(19) United States
(12) Patent Application Publication
(10) Pub. No.: US 2023/0011576 A1
(43) Pub. Date: Jan. 12, 2023

(54) Connecting a Remote User Equipment to a Cellular Network

(71) Applicant: Telefonaktiebolaget LM Ericsson (publ), Stockholm (SE)

(72) Inventors: Zeki Bilgin, Istanbul (TR); Emrah Tomur, Izmir (TR); Elif Ustundag Soykan, Istanbul (TR)

(21) Appl. No.: 17/783,374

(22) PCT Filed: Feb. 25, 2020
(86) PCT No.: PCT/EP2020/054910

§ 371 Date: Jun. 8, 2022

(30) Foreign Application Priority Data
Dec. 11, 2019 (EP) 19404007.7

(51) Int. Cl. H04W 12/71; H04W 60/04; H04W 12/0433; H04W 76/10

(52) U.S. Cl. CPC H04W 12/71; H04W 60/04; H04W 12/0433; H04W 76/10

(57) ABSTRACT

There is provided a performed by a first node for use in connecting a remote user equipment (UE) to a cellular network. An identity of the remote UE is acquired (102). A cryptographic function is applied (104) to the identity of the remote UE to generate a string identity for the remote UE. The string identity for the remote UE is stored (106) in a memory with the identity of the remote UE for use in connecting the remote UE to the cellular network via a relay UE connected to the cellular network.

### TECHNICAL FIELD

The disclosure relates to methods for connecting a remote user equipment to a cellular network and nodes configured to operate in accordance with the methods.

### BACKGROUND

There are a variety of situations in which a remote user equipment (UE) needs to be connected to a cellular network. This cellular network can, for example, enable the remote UE to communicate with other UEs. Some situations may involve a device-to-device (D2D) communication in a cellular network, which is a direct communication between two UEs without traversing a base station or core network.

A proximity-based service (ProSe) is an example of D2D technology that enables long term evolution (LTE) devices to detect each other and communicate directly. TS 23.303 and TS 33.303 are two 3GPP standards related to this technology. TS 23.303 specifies ProSe features in an evolved packet system (EPS), such as ProSe discovery (which can be direct or at evolved packet core (EPC) level) and ProSe direct communication, whereas TS 33.303 specifies the security aspects of ProSe in EPS. One of the functions provided by ProSe is a UE-to-network relay, e.g. for a public safety service. A UE-to-network relay allows authorized UEs to act as a relay node between other UEs (which may be referred to as remote UEs) and the cellular network. For example, a UE-to-network relay can comprise a UE that provides functionality to support connectivity to the cellular network for remote UE(s). In some cases, a remote UE can be a ProSe-enabled and/or public safety service enabled UE that communicates with a packet data network (PDN) via a ProSe UE-to-network relay.

FIG. 1 illustrates an example of an architecture that uses a ProSe UE-to-network relay according to TS 23.303. The ProSe UE-to-network relay communicates with an evolved Node B (eNB) via a reference point (which is referred to as a Uu link). The eNB may communicate with one or more servers, such as a public safety application server (AS), via the EPC and a reference point between the EPC and the one or more servers (which is referred to as a SGi link). In this example, a UE is considered to be a remote UE for a certain ProSe UE-to-network relay if it successfully establishes a reference point (which is referred to as a PC5 link) between ProSe-enabled UEs and the ProSe UE-to-network relay. A Remote UE can be located within evolved universal terrestrial radio access network (E-UTRAN) coverage or outside E-UTRAN coverage.

For ProSe-based communications, there is a functional entity called a ProSe Key Management Function (PKMF) that manages security parameters. Among other tasks, the PKMF performs security procedures, which involve checking if a UE is eligible or authorized to act as a UE-to-network relay or remote UE and, if so, the PKMF provides required shared keys and other security parameters. As part of these security procedures, the remote UE is required to send its identity to UE-to-network relay. For example, the remote UE may send its identity to the PKMF, the PKMF may then provide the remote UE identity (in a key response message) to the UE-to-network relay, and the UE-to-network relay may then provide the remote UE identity to a mobile management entity (MME). The remote UE identity can, for example, be the international mobile subscriber identity (IMSI) for the remote UE or the mobile station international subscriber directory number (MSISDN) for the remote UE.

However, TS 33.303 states that, in general, the IMSI is not to be sent outside of the operator network in order to protect user privacy and the UE-to-network relay cannot be regarded as a network entity in the traditional sense e.g. as an eNB. On the other hand, the PKMF may have a sufficient level of trust in a UE-to-network relay to provide the identity of the remote UE. Even so, the UE-to-network relay is intended to act just as a bridge node between remote UE and network, which means it is intended to forward traffic between the remote UE and network without endangering the confidentiality of flowing traffic and long-term identity of the remote UE. In some cases, instead of sending the actual identity of the remote UE (e.g. the IMSI or the MSISDN for the remote UE), the PKMF may instead send a 128-bit string to the UE-to-network relay. The 128-bit string is such that the MME can map the 128-bit string to the actual identity of the remote UE (e.g. IMSI or MSISDN for the remote UE). This means that mapping information needs to be provisioned into the MME. However, there currently does not exist a technique that allows this mapping to be performed at the MME.

### SUMMARY

It is an object of the disclosure to obviate or eliminate at least some of the above-described disadvantages associated with existing techniques and provide an improved technique for connecting a remote user equipment (UE) to a cellular network.

Therefore, according to an aspect of the disclosure, there is provided a method performed by a first node for use in connecting a remote UE to a cellular network. The method comprises acquiring an identity of the remote UE, applying a cryptographic function to the identity of the remote UE to generate a string identity for the remote UE and storing, in a memory, the string identity for the remote UE with the identity of the remote UE for use in connecting the remote UE to the cellular network via a relay UE connected to the cellular network.

There is thus provided an improved method for use in connecting the remote UE to the cellular network. Although the identity of the remote UE is acquired by the first node, the first node protects the identity of the remote UE as a cryptographic function is applied to it to generate a string identity for the remote UE. The real identity of the remote UE is stored with this string identity for the remote UE such that (trusted) nodes can retrieve the real identity of the UE. However, the string identity of the UE is available for use by other nodes, such as the relay UE. The privacy of the real identity of the remote UE can thus be protected against the relay UE, since the relay UE cannot deduce the remote UE identity from the string identity for the UE. In this way, the remote UE can be provided with access to the cellular network via the relay UE without compromising its real identity.

In some embodiments, the method may comprise truncating the string identity for the remote UE and storing, in the memory, the truncated string identity for the remote UE with the identity of the remote UE for use in connecting the remote UE to the cellular network via the relay UE connected to the cellular network. In this way, the length of the string identity can be adjusted, e.g. according to the requirements of any underlying network protocols. For example, there may be a standard requirement on the bit length of the identity of the remote UE and thus the length of the string identity can be adjusted to meet this requirement by way of the truncation. At the same time, a string identity having a greater number of bits can be generated to increase the security provided to protect the real identity of the UE. Moreover, the truncation also means that the resources used for storage of the string identity can be minimised.

In some embodiments, the method may comprise appending random data to the identity of the remote UE and applying the cryptographic function to the identity of the remote UE together with the random data appended to the identity of the remote UE to generate the string identity for the remote UE. In this way, the privacy of the real identity of the remote UE can be protected even more securely, since dictionary or pre-computed attacks can be eliminated.

In some embodiments, the method may comprise generating an updated string identity for the remote UE and storing, in the memory, the updated string identity for the remote UE with the identity of the remote UE for use in connecting the remote UE to the cellular network via the relay UE connected to the cellular network. In this way, the privacy of the real identity of the remote UE can be protected even more securely.

In some embodiments, generating an updated string identity for the remote UE may comprise appending different random data to the identity of the remote UE and applying the cryptographic function to the identity of the remote UE together with the different random data appended to the identity of the remote UE to generate the updated string identity for the remote UE. In this way, the privacy of the real identity of the remote UE can be protected even more securely.

In some embodiments, acquiring the identity of the remote UE, applying the cryptographic function and storing the string identity for the remote UE may be performed in response to the remote UE registering with the cellular network. In this way, the method is more efficient since a string identity is available for the remote UE as soon as the remote UE is registered with the cellular network.

In some embodiments, the remote UE may be registered for a proximity-based service, (ProSe) and the cellular network may be a ProSe enabled cellular network.

According to another aspect of the disclosure, there is provided a first node comprising processing circuitry configured to operate in accordance with the method described earlier in respect of the first node. The first node thus provides the advantages discussed earlier in respect of the method performed by the first node. In some embodiments, the first node may comprise at least one memory for storing instructions which, when executed by the processing circuitry, cause the first node to operate in accordance with the method described earlier in respect of the first node. In some embodiments, the first node may be a home subscriber server (HSS) or a bootstrapping server function (BSF) node.

According to another aspect of the disclosure, there is provided a method performed by a second node for use in connecting a remote user equipment (UE) to a cellular network. The method comprises acquiring a string identity for the remote UE from a first node. The string identity for the remote UE comprises a cryptographic function applied to the identity of the remote UE. The method comprises initiating transmission of the string identity for the remote UE towards a relay UE connected to the cellular network for use in connecting the remote UE to the cellular network via the relay UE.

There is thus provided an improved method for use in connecting the remote UE to the cellular network. The second node acquires and initiates transmission of the string identity for the remote UE and not the real identity of the remote UE. The real identity of the remote UE is protected as a cryptographic function is applied to it to generate the string identity for the remote UE. Thus, the relay UE only receives the string identity for the remote UE and not the real identity of the UE. The privacy of the real identity of the remote UE is thus protected against the relay UE, since the relay UE cannot deduce the remote UE identity from the string identity for the UE. In this way, the remote UE can be provided with access to the cellular network via the relay UE without compromising its real identity.

In some embodiments, the string identity for the remote UE may be a truncated string identity. In this way, the length of the string identity can be adjusted, e.g. according to the requirements of any underlying network protocols. For example, there may be a standard requirement on the bit length of the identity of the remote UE and thus the length of the string identity can be adjusted to meet this requirement by way of the truncation. At the same time, a string identity having a greater number of bits can be generated to increase the security provided to protect the real identity of the UE. Moreover, the truncation also means that the resources used for the acquisition and transmission of the string identity can be minimised. Alternatively or in addition, in some embodiments, the string identity for the remote UE may comprise the cryptographic function applied to the identity of the remote UE together with random data appended to the identity of the remote UE. In this way, the privacy of the real identity of the remote UE can be protected even more securely, since dictionary or pre-computed attacks can be eliminated.

In some embodiments, the remote UE may be registered for a proximity-based service (ProSe) and the cellular network may be a ProSe enabled cellular network.

According to another aspect of the disclosure, there is provided a second node comprising processing circuitry configured to operate in accordance with the method described earlier in respect of the second node. The second node thus provides the advantages discussed earlier in respect of the method performed by the second node. In some embodiments, the second node may comprise at least one memory for storing instructions which, when executed by the processing circuitry, cause the second node to operate in accordance with the method described earlier in respect of the second node. In some embodiments, the second node may be the remote UE or a key management function (KMF) node of the relay UE.

According to another aspect of the disclosure, there is provided a method performed by a third node for use in connecting a remote user equipment (UE) to a cellular network. The method comprises, in response to receiving a string identity for the remote UE, acquiring, from a first node, an identity of the remote UE that is stored in a memory with the string identity for the remote UE and establishing a connection between the remote UE and the cellular network via a relay UE connected to the cellular network using the identity of the remote UE. The string identity for the remote UE comprises a cryptographic function applied to the identity of the remote UE.

There is thus provided an improved method for use in connecting the remote UE to the cellular network. The third node receives the string identity for the remote UE and not the real identity of the remote UE. As a cryptographic function is applied to the identity of the remote UE to generate the string identity for the remote UE, the real identity of the remote UE is protected when the string identity for the remote UE is transmitted to be received by the third node. The privacy of the real identity of the remote UE is thus protected against the relay UE, since the relay UE cannot deduce the remote UE identity from the string identity for the UE. However, the third node is able to map this string identity for the UE to the real identity of the UE in order to establish the connection between the remote UE and the cellular network via the relay UE. In this way, the remote UE can be provided with access to the cellular network via the relay UE without compromising its real identity.

In some embodiments, the string identity for the remote UE may be a truncated string identity. In this way, the length of the string identity can be adjusted, e.g. according to the requirements of any underlying network protocols. For example, there may be a standard requirement on the bit length of the identity of the remote UE and thus the length of the string identity can be adjusted to meet this requirement by way of the truncation. At the same time, a string identity having a greater number of bits can be generated to increase the security provided to protect the real identity of the UE. Moreover, the resources used for receiving the string identity and the acquisition of the identity of the remote UE can be minimised. Alternatively or in addition, in some embodiments, the string identity for the remote UE may comprise the cryptographic function applied to the identity of the remote UE together with random data appended to the identity of the remote UE. In this way, the privacy of the real identity of the remote UE can be protected even more securely, since dictionary or pre-computed attacks can be eliminated.

In some embodiments, the remote UE may be registered for a proximity-based service (ProSe) and the cellular network may be a ProSe enabled cellular network.

According to another aspect of the disclosure, there is provided a third node comprising processing circuitry configured to operate in accordance with the method described earlier in respect of the third node. The third node thus provides the advantages discussed earlier in respect of the method performed by the third node. In some embodiments, the third node may comprise at least one memory for storing instructions which, when executed by the processing circuitry, cause the third node to operate in accordance with the method described earlier in respect of the third node. In some embodiments, the third node may be a key management function (KMF) node of the relay UE node or a mobile management entity (MME).

According to another aspect of the disclosure, there is provided a system comprising, one or more first nodes as described earlier, one or more second nodes as described earlier, and/or one or more third nodes as described earlier. The system thus provides the advantages discussed earlier in respect of the method performed by the first node, the second node and/or the third node.

According to another aspect of the disclosure, there is provided a computer program comprising instructions which, when executed by processing circuitry, cause the processing circuitry to perform the method described earlier. The computer program thus provides the advantages discussed earlier in respect of the method performed by the first node, the second node and/or the third node.

According to another aspect of the disclosure, there is provided a computer program product, embodied on a non-transitory machine-readable medium, comprising instructions which are executable by processing circuitry to cause the processing circuitry to perform the method described earlier. The computer program product thus provides the advantages discussed earlier in respect of the method performed by the first node, the second node and/or the third node.

Therefore, an advantageous technique for connecting a remote user equipment to a cellular network is provided.

### BRIEF DESCRIPTION OF THE DRAWINGS

For a better understanding of the technique, and to show how it may be put into effect, reference will now be made, by way of example, to the accompanying drawings, in which:

FIG. 1 is a block diagram illustrating an example architecture;

FIG. 2 is a block diagram illustrating a first node according to an embodiment;

FIG. 3 is a block diagram illustrating a method performed by a first node according to an embodiment;

FIG. 4 is a block diagram illustrating a second node according to an embodiment;

FIG. 5 is a block diagram illustrating a method performed by a second node according to an embodiment;

FIG. 6 is a block diagram illustrating a third node according to an embodiment;

FIG. 7 is a block diagram illustrating a method performed by a third node according to an embodiment;

FIG. 8 is a block diagram illustrating a method performed by a first node according to an embodiment;

FIG. 9 is a block diagram illustrating a method performed by a second node and a third node according to an embodiment;

FIG. 10 is a block diagram illustrating a method performed by a second node according to an embodiment;

FIG. 11 is an example of information stored in a memory according to an embodiment;

FIG. 12(a)-(b) is a signalling diagram illustrating an exchange of signals in a system according to an embodiment;

FIG. 13 is a block diagram illustrating a first node according to an embodiment;

FIG. 14 is a block diagram illustrating a second node according to an embodiment; and

FIG. 15 is a block diagram illustrating a third node according to an embodiment.

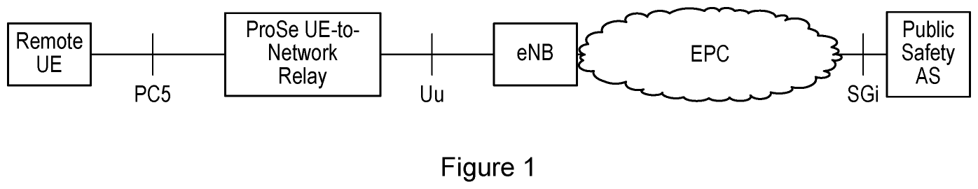

### DETAILED DESCRIPTION

As mentioned earlier, an advantageous technique for connecting a remote user equipment (UE) to a cellular network is described herein. The technique is implemented by a first node, a second node, and a third node. In some embodiments, the cellular network referred to herein may be radio access network (RAN), such as an evolved universal terrestrial radio access network (E-UTRAN), or any other cellular network. In some embodiments, the cellular network may be a packet data network (PDN). Herein, a node may also be referred to as an entity.

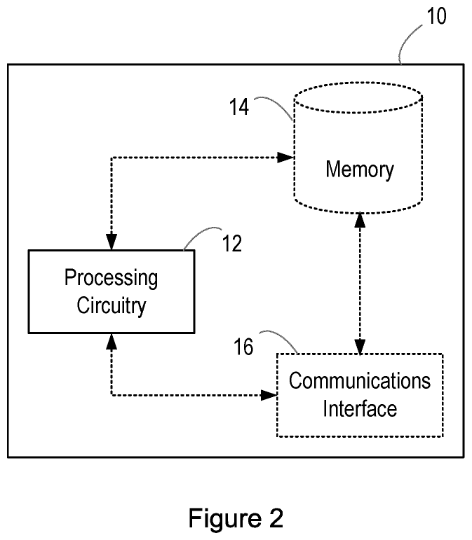

FIG. 2 illustrates a first node 10 of a network in accordance with an embodiment. The first node 10 is for use in connecting a remote UE to a cellular network. The first node 10 can, for example, be a home subscriber server (HSS) or a bootstrapping server function (BSF) node.

The remote UE can, for example, be a mobile terminal (e.g. a smartphone, a tablet, a laptop, a wearable such as a virtual reality headset, or any other mobile terminal) or a stationary terminal (e.g. a fixed phone, a computer, or any other stationary terminal). In some embodiments, the remote UE can, for example, be a device (e.g. a media device, a smart meter, or any other device), a machine, a sensor, an actuator, a camera, a car, or any other entity that wishes to connect to the cellular network. In some embodiments, the remote UE can be for use in machine-to machine (M2M) or device-to device (D2D) communications. In some embodiments, the remote UE can be part of the internet of things (IoT).

In some embodiments, the remote UE may be registered for a proximity-based service (ProSe) and the cellular network may be a ProSe enabled cellular network. Herein, a ProSe will be understood to mean a service that becomes available to the remote UE when the remote UE enters a predefined area and/or is within a predefined distance of a node providing the service. Alternatively or in addition, in some embodiments, the remote UE may be registered for a public safety service, such as a police service, a fire service, and/or any other public safety service.

As illustrated in FIG. 2, the first node 10 comprises processing circuitry (or logic) 12. The processing circuitry 12 controls the operation of the first node 10 and can implement the method described herein. The processing circuitry 12 can comprise one or more processors, processing units, multi-core processors or modules that are configured or programmed to control the first node 10 in the manner described herein. In particular implementations, the processing circuitry 12 of the first node 10 can comprise a plurality of software and/or hardware modules that are each configured to perform, or are for performing, individual or multiple steps of the method described herein.

Briefly, the processing circuitry 12 of the first node 10 is configured to acquire an identity of the remote UE and apply a cryptographic function to the identity of the remote UE to generate a string identity for the remote UE. The processing circuitry 12 of the first node 10 is also configured to store, in a memory, the string identity for the remote UE with the identity of the remote UE for use in connecting the remote UE to the cellular network via a relay UE connected to the cellular network.

As illustrated in FIG. 2, in some embodiments, the first node 10 may optionally comprise a memory 14. The memory 14 of the first node 10 can comprise a volatile memory or a non-volatile memory. In some embodiments, the memory 14 of the first node 10 may comprise a non-transitory media. Examples of the memory 14 of the first node 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the first node 10 can be connected to the memory 14 of the first node 10. In some embodiments, the memory 14 of the first node 10 may be for storing program code or instructions which, when executed by the processing circuitry 12 of the first node 10, cause the first node 10 to operate in the manner described herein in respect of the first node 10. For example, in some embodiments, the memory 14 of the first node 10 may be configured to store program code or instructions that can be executed by the processing circuitry 12 of the first node 10 to cause the first node 10 to operate in accordance with the method described herein in respect of the first node 10. Alternatively or in addition, the memory 14 of the first node 10 can be configured to store any information (e.g. the identity of the remote UE and/or the string identity for the remote UE), data, messages, requests, responses, indications, notifications, signals, or similar, that are described herein. The processing circuitry 12 of the first node 10 may be configured to control the memory 14 of the first node 10 to store information (e.g. the identity of the remote UE and/or the string identity for the remote UE), data, messages, requests, responses, indications, notifications, signals, or similar, that are described herein.

In some embodiments, the memory 14 of the first node 10 can be configured to store the string identity for the remote UE with the identity of the remote UE for use in connecting the remote UE to the cellular network via the relay UE connected to the cellular network. For example, in some embodiments, the processing circuitry 12 of the first node 10 can be configured to store this string identity in the memory 14 of the first node 10. Alternatively or in addition, in some embodiments, the processing circuitry 12 of the first node 10 can be configured to store this string identity in a memory external to (e.g. separate to or remote from) the first node 10.

In some embodiments, as illustrated in FIG. 2, the first node 10 may optionally comprise a communications interface 16. The communications interface 16 of the first node 10 can be connected to the processing circuitry 12 of the first node 10 and/or the memory 14 of first node 10. The communications interface 16 of the first node 10 may be operable to allow the processing circuitry 12 of the first node 10 to communicate with the memory 14 of the first node 10 and/or vice versa. Similarly, the communications interface 16 of the first node 10 may be operable to allow the processing circuitry 12 of the first node 10 to communicate with the second node, the third node, and/or any other node. The communications interface 16 of the first node 10 can be configured to transmit and/or receive information (e.g. the identity of the remote UE and/or the string identity for the remote UE), data, messages, requests, responses, indications, notifications, signals, or similar, that are described herein. In some embodiments, the processing circuitry 12 of the first node 10 may be configured to control the communications interface 16 of the first node 10 to transmit and/or receive information (e.g. the identity of the remote UE and/or the string identity for the remote UE), data, messages, requests, responses, indications, notifications, signals, or similar, that are described herein.

Although the first node 10 is illustrated in FIG. 2 as comprising a single memory 14, it will be appreciated that the first node 10 may comprise at least one memory (i.e. a single memory or a plurality of memories) 14 that operate in the manner described herein. Similarly, although the first node 10 is illustrated in FIG. 2 as comprising a single communications interface 16, it will be appreciated that the first node 10 may comprise at least one communications interface (i.e. a single communications interface or a plurality of communications interface) 16 that operate in the manner described herein. It will also be appreciated that FIG. 2 only shows the components required to illustrate an embodiment of the first node 10 and, in practical implementations, the first node 10 may comprise additional or alternative components to those shown.

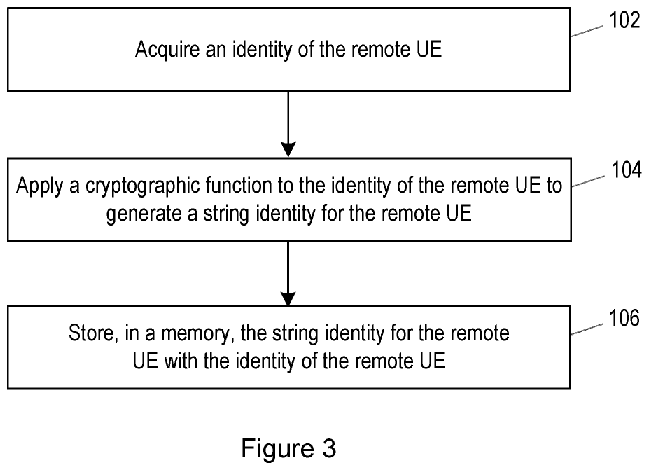

FIG. 3 is a flowchart illustrating a method performed by a first node 10 in accordance with an embodiment. The method is for use in connecting a remote UE to a cellular network. The first node 10 described earlier with reference to FIG. 2 is configured to operate in accordance with the method of FIG. 3. The method can be performed by or under the control of the processing circuitry 12 of the first node 10.

As illustrated at block 102 of FIG. 3, an identity of the remote UE is acquired. More specifically, the processing circuitry 12 of the first node 10 acquires the identity of the remote UE. In some embodiments, the identity of the remote UE may be acquired from the remote UE itself. At block 104 of FIG. 3, a cryptographic function is applied to the identity of the remote UE to generate a string identity for the remote UE. More specifically, the processing circuitry 12 of the first node 10 applies the cryptographic function to the identity of the remote UE to generate the string identity for the remote UE. Thus, the cryptographic function is provided with the identity of the remote UE as input and generates a string identity for the remote UE as output.

The string identity referred to herein may be of a fixed length. In some embodiments, the string identity referred to herein may be a string identity of at least 256 bits (i.e. 256 bits or more than 256 bits) for the remote UE or at least 128 bits (i.e. 128 bits or more than 128 bits) for the remote UE. The length of the string identity the remote UE may be increased in order to increase the level of security provided to protect the real identity of the remote UE. In some embodiments, the output of the cryptographic function may be a binary output, which can be converted into a string identity for the remote UE. For example, a binary output may be expressed in hexadecimal form to convert it into a string identity for the remote UE. The string identity referred to herein is unique to the remote UE. In particular, a cryptographic function can generate unique string identities provided that the inputs (i.e. the identities of the remote UEs) into the cryptographic function are different. The string identity referred to herein can be resistant to dictionary attacks.

In some embodiments, the cryptographic function referred to herein may be a cryptographic hash function, e.g. Secure Hash Algorithm 2 (SHA-2). A cryptographic hash function is a one way function, which can improve the security of the identity of the remote UE. A cryptographic hash function can generate a message digest (e.g. of a fixed length). Thus, in some embodiments, the cryptographic hash function can be provided with the identity of the remote UE as input and generate a message digest for the remote UE as output. In these embodiments, the string identity referred to herein can be a message digest. The message digest may have desirable properties, such as ignorable collision likelihood (i.e. uniqueness) and resistance against recovering the original identity of the UE from its message digest. In some embodiments, the cryptographic function referred to herein may be a key derivation function (KDF) such as a password-based key derivation function, e.g. Password-Based Key Derivation Function 2 (pbkdf2). In some embodiments, the cryptographic function referred to herein may be a hash-based message authentication code (HMAC) function. Although examples have been provided for the cryptographic function, a person skilled in the art will be aware of other cryptographic functions that may be used.

Returning back to FIG. 3, at block 104, the string identity for the remote UE is stored in a memory (e.g. the memory 14 of the first node 10 and/or any other memory) with the identity of the remote UE for use in connecting the remote UE to the cellular network via the relay UE connected to the cellular network. More specifically, the processing circuitry 12 of the first node 10 stores the string identity for the remote UE in the memory with the identity of the remote UE. Thus, once a string identity is generated for the remote UE, it is stored in a memory with the identity of the remote UE. In this way, the string identity for the remote UE is mapped to the corresponding identity of the remote UE. In some embodiments, this relationship may be maintained in a table. The second node and/or the third node described herein can retrieve the string identity for the remote UE identity corresponding to the actual identity of the remote UE from the first node 10 when required.

The relay UE referred to herein is any UE connected to the cellular network that can provide functionality to support connectivity to the cellular network for remote UE or can relay traffic (e.g. communications such as calls, messages, etc.) from the remote UE to the cellular network. The relay UE may thus also be referred to herein as a UE-to-network relay (or a ProSe UE-to-network relay in embodiments where the cellular network is a ProSe enabled cellular network). The relay UE referred to herein can be a UE that it authorized to connect to the cellular network. The remote UE referred to herein can be a UE that connects to the cellular network via a relay UE, e.g. as it is not authorized to do so and/or is out of the coverage area of the cellular network.

In some embodiments, the relay UE referred to herein may be inside a coverage area of the cellular network. In some embodiments, the remote UE referred to herein may outside or inside the coverage area of the cellular network. Thus, the privacy of the identity of the remote UE can be protected irrespective of whether the remote UE is outside or inside the coverage area of the cellular network. That is, the privacy of the identity of the remote UE can be protected even when the remote UE is outside the coverage area of the cellular network.

In some embodiments, acquiring the identity of the remote UE (at block 102 of FIG. 3), applying the cryptographic function (at block 104 of FIG. 3), and storing the string identity for the remote UE (at block 106 of FIG. 3) may be performed in response to the remote UE registering with or being provisioned to the cellular network. In some embodiments, the method described with reference to FIG. 3 may be performed by default when the remote UE registers with or is provisioned to the cellular network. This may be regardless of whether the remote UE attempts to connect to the relay UE. In this way, the remote UE is able to provide its string identity to the remote UE even when it is out of a coverage area of the cellular network.

In some embodiments where the remote UE is registered for a ProSe and/or public safety service, acquiring the identity of the remote UE (at block 102 of FIG. 3), applying the cryptographic function (at block 104 of FIG. 3), and storing the string identity for the remote UE (at block 106 of FIG. 3) may be performed in response to the remote UE registering with or being provisioned to the ProSe and/or public safety service. In some embodiments, the method described with reference to FIG. 3 may be performed by default when the remote UE registers with or is provisioned to the ProSe and/or public safety service. This may be regardless of whether the remote UE attempts to connect to the relay UE.

Although not illustrated in FIG. 3, in some embodiments, the method may comprise truncating the string identity for the remote UE. More specifically, the processing circuitry 12 of the first node 10 can be configured to truncate the string identity for the remote UE according to some embodiments. For example, in some embodiments, the string identity referred to herein may be a truncated string identity of 128 bits or less.

In embodiments involving truncation, the method may comprise storing, in the memory (e.g. the memory 14 of the first node 10 and/or any other memory), the truncated string identity for the remote UE with the identity of the remote UE for use in connecting the remote UE to the cellular network via the relay UE connected to the cellular network. More specifically, the processing circuitry 12 of the first node 10 can be configured to store the truncated string identity for the remote UE in the memory with the identity of the remote UE according to these embodiments. This allows the use of a cryptographic function that results in a longer output, which is more secure, as the output can then be truncated. In this way, the length of the string identity (or, in embodiments where a cryptographic hash function is used, the length of the message digest) for the remote UE may be increased in order to increase the level of security provided to protect the real identity of the remote UE. Moreover, the resources used for storage of the string identity can be minimised by truncating it prior to storage.

In some embodiments, the length of the string identity (or, in embodiments where a cryptographic hash function is used, the length of the message digest) can be adjusted according to the requirements of any underlying network protocols. For example, there may be a standard requirement on the bit length of the identity of the remote UE and thus, in some embodiments, the length of the string identity (or, in embodiments where a cryptographic hash function is used, the length of the message digest) can be adjusted by way of the truncation to meet this requirement. A person skilled in the art will be aware of various ways in which the string identity for the remote UE can be truncated, but examples include those allowed in the secure hash standard (NIST FIPS 180-4) such as truncating the leftmost bits and other techniques such as using an XOR cipher on different parts of the string identity.

Although also not illustrated in FIG. 3, in some embodiments, the method may comprise appending random data (e.g. a random string or a salt) to the identity of the remote UE. More specifically, the processing circuitry 12 of the first node 10 can be configured to append random data to the identity of the remote UE according to some embodiments. That is, a concatenation of the identity of the remote UE and the random data is generated according to some embodiments. In these embodiments, the method may comprise applying the cryptographic function to the identity of the remote UE together with the random data appended to the identity of the remote UE to generate the string identity for the remote UE. More specifically, the processing circuitry 12 of the first node 10 can be configured to apply the cryptographic function to the identity of the remote UE together with the random data appended to the identity of the remote UE to generate the string identity for the remote UE according to these embodiments. In an example where the cryptographic function is a cryptographic hash function, this may be expressed as:

H(Identity of UE∥Random Data)→message digest,

where H is a cryptographic hash function and ∥ denotes concatenation.

Thus, in some embodiments, the string identity for the remote UE may comprise the cryptographic function applied to the identity of the remote UE together with random data appended to the identity of the remote UE. In this way, the real identity of the remote UE can be more securely protected. In particular, dictionary or pre-computed attacks (e.g. where a cryptographic function is fed with all possible values and the result compared to the string identity to determine the real identity of the remote UE) can be eliminated.

In some embodiments, the method performed by the first node 10 may comprise generating the random data. More specifically, the processing circuitry 12 of the first node 10 can be configured to generate the random data according to some embodiments. In other embodiments, the method performed by the first node 10 may comprise acquiring the random data, for example, from another node or a memory such as the memory 14 of the first node 10 and/or any other memory. More specifically, the processing circuitry 12 of the first node 10 can be configured to acquire the random data according to some embodiments. Thus, in some embodiments, another node may generate the random data.

There are several logical and functional network nodes that are capable of generating identities or random numbers with desired properties for certain network protocols and operations, e.g. a key management function (KMF) node such as a ProSe key management function (PKMF) node, a mobile management entity (MME), or a HSS. In some embodiments, the HSS may generate the random data. This can be advantageous as the HSS can maintain a list of UEs with their subscription information (e.g. for ProSe and/or public safety service), store an identity (e.g. an IMSI) of each UE, and is capable of providing information (e.g. credentials) to other nodes. In some embodiments, the HSS may generate random data and associate that random data to the identity of the UE.

In some embodiments, the string identity for the remote UE may be associated to the corresponding identity of the remote UE permanently, e.g. without renewal. On the other hand, although not illustrated in FIG. 3, in some embodiments, the method may comprise generating an updated string identity for the remote UE. More specifically, the processing circuitry 12 of the first node 10 can be configured to generate an updated string identity for the remote UE according to some embodiments. Thus, in some embodiments, the string identity for the remote UE may be regenerated. The string identity for the remote UE may be updated at predefined time intervals, e.g. regularly. The string identity and any updated string identity may be generated without an expiration date or time. In this way, it can be ensured that the string identity and any updated string identity are valid even when the remote UE is outside the coverage area of the cellular network.

In some embodiments, when the string identity for the remote UE is updated, the updated string identity for the remote UE may be stored in the memory (e.g. the memory 14 of the first node 10 or any other memory) with the identity of the remote UE for use in connecting the remote UE to the cellular network via a relay UE connected to the cellular network. More specifically, the processing circuitry 12 of the first node 10 can be configured to store the updated string identity for the remote UE in the memory according to some embodiments. In some embodiments, the updated string identity for the remote UE may replace the previous string identity for the remote UE stored in the memory. Thus, the previous string identity for the remote UE may become invalid.

In some embodiments involving updating the string identity for the remote UE, the method may comprise storing, in the memory (e.g. the memory 14 of the first node 10 and/or any other memory), the updated string identity for the remote UE with the identity of the remote UE for use in connecting the remote UE to the cellular network via the relay UE connected to the cellular network. More specifically, the processing circuitry 12 of the first node 10 can be configured to store the updated string identity for the remote UE in the memory with the identity of the remote UE according to these embodiments.

In some of these embodiments, generating an updated string identity for the remote UE may comprise appending different random data (e.g. a different random string or a different salt) to the identity of the remote UE and applying the cryptographic function to the identity of the remote UE together with the different random data appended to the identity of the remote UE to generate the updated string identity for the remote UE. More specifically, in some of these embodiments, the processing circuitry 12 of the first node 10 can be configured to append different random data to the identity of the remote UE and apply the cryptographic function to the identity of the remote UE together with the different random data appended to the identity of the remote UE to generate the updated string identity for the remote UE.

In some embodiments, the method may comprise generating the different random data. More specifically, the processing circuitry 12 of the first node 10 can be configured to generate the different random data according to some embodiments. In other embodiments, the method may comprise acquiring the different random data, for example, from a memory such as the memory 14 of the first node 10 and/or any other memory. More specifically, the processing circuitry 12 of the first node 10 can be configured to acquire the different random data according to some embodiments.

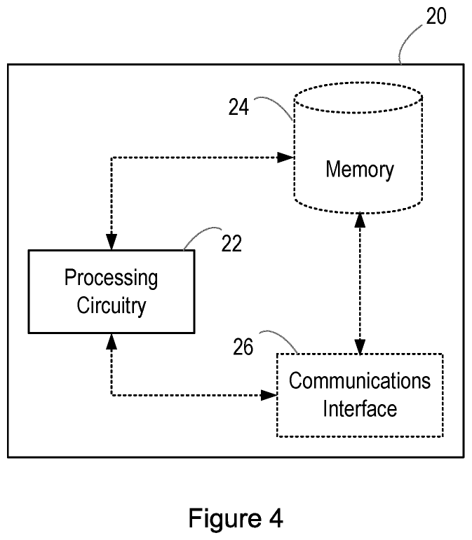

FIG. 4 illustrates a second node 20 of a network in accordance with an embodiment. The second node 20 is for use in connecting a remote UE to a cellular network. In some embodiments, the second node 20 may be the remote UE or a key management function (KMF) node of a relay UE, such as a ProSe key management function (PKMF) node of the relay UE.

As mentioned earlier, the remote UE can, for example, be a mobile terminal (e.g. a smartphone, a tablet, a laptop, a wearable such as a virtual reality headset, or any other mobile terminal) or a stationary terminal (e.g. a fixed phone, a computer, or any other stationary terminal). In some embodiments, the remote UE can, for example, be a device (e.g. a media device, a smart meter, or any other device), a machine, a sensor, an actuator, a camera, a car, or any other entity that wishes to connect to the cellular network. In some embodiments, the remote UE can be for use in M2M or D2D communications. In some embodiments, the remote UE can be part of the internet of things (IoT). In some embodiments, as described earlier, the remote UE may be registered for ProSe and the cellular network may be a ProSe enabled cellular network. Alternatively or in addition, in some embodiments, the remote UE may be registered for a public safety service as described earlier.

As illustrated in FIG. 4, the second node 20 comprises processing circuitry (or logic) 22. The processing circuitry 22 controls the operation of the second node 20 and can implement the method described herein. The processing circuitry 22 can comprise one or more processors, processing units, multi-core processors or modules that are configured or programmed to control the second node 20 in the manner described herein. In particular implementations, the processing circuitry 22 of the second node 20 can comprise a plurality of software and/or hardware modules that are each configured to perform, or are for performing, individual or multiple steps of the method described herein.

Briefly, the processing circuitry 22 of the second node 20 is configured to acquire a string identity for the remote UE from a first node 10 and initiate transmission of the string identity for the remote UE towards a relay UE connected to the cellular network for use in connecting the remote UE to the cellular network via the relay UE. As mentioned earlier, the string identity for the remote UE comprises a cryptographic function applied to the identity of the remote UE.

As illustrated in FIG. 4, in some embodiments, the second node 20 may optionally comprise a memory 24. The memory 24 of the second node 20 can comprise a volatile memory or a non-volatile memory. In some embodiments, the memory 24 of the second node 20 may comprise a non-transitory media. Examples of the memory 24 of the second node 20 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 22 of the second node 20 can be connected to the memory 24 of the second node 20. In some embodiments, the memory 24 of the second node 20 may be for storing program code or instructions which, when executed by the processing circuitry 22 of the second node 20, cause the second node 20 to operate in the manner described herein in respect of the second node 20. For example, in some embodiments, the memory 24 of the second node 20 may be configured to store program code or instructions that can be executed by the processing circuitry 22 of the second node 20 to cause the second node 20 to operate in accordance with the method described herein in respect of the second node 20. Alternatively or in addition, the memory 24 of the second node 20 can be configured to store any information (e.g. the identity of the remote UE and/or the string identity for the remote UE), data, messages, requests, responses, indications, notifications, signals, or similar, that are described herein. The processing circuitry 22 of the second node 20 may be configured to control the memory 24 of the second node 20 to store any information (e.g. the identity of the remote UE and/or the string identity for the remote UE), data, messages, requests, responses, indications, notifications, signals, or similar, that are described herein.

In some embodiments, as illustrated in FIG. 4, the second node 20 may optionally comprise a communications interface 26. The communications interface 26 of the second node 20 can be connected to the processing circuitry 22 of the second node 20 and/or the memory 24 of second node 20. The communications interface 26 of the second node 20 may be operable to allow the processing circuitry 22 of the second node 20 to communicate with the memory 24 of the second node 20 and/or vice versa. Similarly, the communications interface 26 of the second node 20 may be operable to allow the processing circuitry 22 of the second node 20 to communicate with the first node 10, the third node, and/or any other node. The communications interface 26 of the second node 20 can be configured to transmit and/or receive any information (e.g. the identity of the remote UE and/or the string identity for the remote UE), data, messages, requests, responses, indications, notifications, signals, or similar, that are described herein. In some embodiments, the processing circuitry 22 of the second node 20 may be configured to control the communications interface 26 of the second node 20 to transmit and/or receive any information (e.g. the identity of the remote UE and/or the string identity for the remote UE), data, messages, requests, responses, indications, notifications, signals, or similar, that are described herein.

Although the second node 20 is illustrated in FIG. 4 as comprising a single memory 24, it will be appreciated that the second node 20 may comprise at least one memory (i.e. a single memory or a plurality of memories) 24 that operate in the manner described herein. Similarly, although the second node 20 is illustrated in FIG. 4 as comprising a single communications interface 26, it will be appreciated that the second node 20 may comprise at least one communications interface (i.e. a single communications interface or a plurality of communications interface) 26 that operate in the manner described herein. It will also be appreciated that FIG. 4 only shows the components required to illustrate an embodiment of the second node 20 and, in practical implementations, the second node 20 may comprise additional or alternative components to those shown.

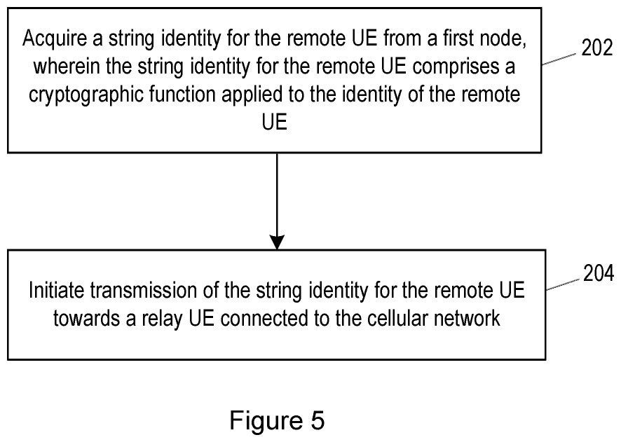

FIG. 5 is a flowchart illustrating a method performed by a second node 20 in accordance with an embodiment. The method is for use in connecting a remote UE to a cellular network. The second node 20 described earlier with reference to FIG. 4 is configured to operate in accordance with the method of FIG. 5. The method can be performed by or under the control of the processing circuitry 22 of the second node 20.

As illustrated in FIG. 5, at block 202, a string identity is acquired for the remote UE from a first node 10. More specifically, the processing circuitry 22 of the second node 20 acquires the string identity for the remote UE from the first node 10.

At block 204 of FIG. 5, transmission of the string identity for the remote UE is initiated towards a relay UE connected to the cellular network for use in connecting the remote UE to the cellular network via the relay UE. More specifically, the processing circuitry 22 of the second node 20 initiates transmission of the string identity for the remote UE towards the relay UE connected to the cellular network. Herein, the term “initiate” can mean, for example, cause or establish. Thus, the processing circuitry 22 of the second node 20 can be configured to itself transmit the string identity for the remote UE towards the relay UE connected to the cellular network or can be configured to cause another node to transmit the string identity for the remote UE towards the relay UE connected to the cellular network. In this way, the string identity for the remote UE can be distributed to the relay UE for use in connecting the remote UE to the cellular network.

As mentioned earlier, the string identity for the remote UE comprises a cryptographic function applied to the identity of the remote UE. In some embodiments, the string identity for the remote UE may comprise the cryptographic function applied to the identity of the remote UE together with random data appended to the identity of the remote UE. That is, in some embodiments, the string identity for the remote UE may comprise the cryptographic function applied to a concatenation of the identity of the remote UE and the random data. In some embodiments, the string identity referred to herein may be a string identity of at least 256 bits (i.e. 256 bits or more than 256 bits) for the remote UE or at least 128 bits (i.e. 128 bits or more than 128 bits) for the remote UE. In some embodiments, the string identity for the remote UE may be a truncated string identity. For example, in some embodiments, the string identity referred to herein may be a truncated string identity of 128 bits or less. In some embodiments, the cryptographic function may be any of the cryptographic functions described earlier, such as a cryptographic hash function (e.g. SHA-2), a KDF (e.g. pbkdf2), a HMAC function, or any other cryptographic function.

Although not illustrated in FIG. 5, in some embodiments, the method may comprise storing the string identity for the remote UE in a memory (e.g. the memory 24 of the second node 20 and/or any other memory). More specifically, the processing circuitry 12 of the first node 10 can be configured to store the string identity for the remote UE in the memory. Thus, in embodiments where the second node 20 is the remote UE, the remote UE may itself maintain the string identity (and any updated string identities) assigned to it.

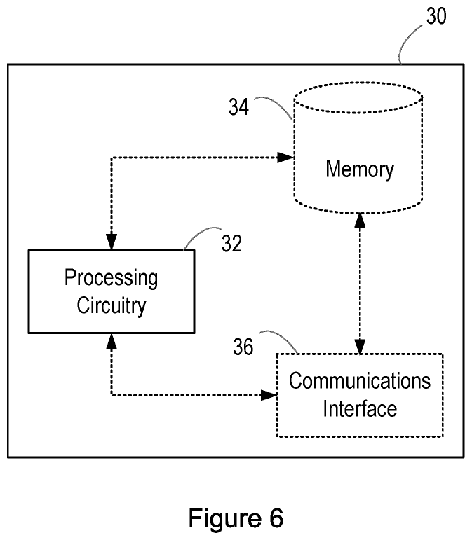

FIG. 6 illustrates a third node 30 of a network in accordance with an embodiment. The third node 30 is for use in connecting a remote UE to a cellular network. In some embodiments, the third node 30 may be a key management function (KMF) node of a relay UE, such as a ProSe key management function (PKMF) node of the relay UE, or a mobile management entity (MME). The MME can be an MME of a core network. The third node 30 described herein can be a trusted node. There may be a secure connection between the remote UE and the third node 30.

As mentioned earlier, the remote UE can, for example, be a mobile terminal (e.g. a smartphone, a tablet, a laptop, a wearable such as a virtual reality headset, or any other mobile terminal) or a stationary terminal (e.g. a fixed phone, a computer, or any other stationary terminal). In some embodiments, the remote UE can, for example, be a device (e.g. a media device, a smart meter, or any other device), a machine, a sensor, an actuator, a camera, a car, or any other entity that wishes to connect to the cellular network. In some embodiments, the remote UE can be for use in M2M or D2D communications. In some embodiments, the remote UE can be part of the internet of things (IoT). In some embodiments, as described earlier, the remote UE may be registered for a ProSe and the cellular network may be a ProSe enabled cellular network. Alternatively or in addition, in some embodiments, the remote UE may be registered for public safety service as described earlier.

As illustrated in FIG. 6, the third node 30 comprises processing circuitry (or logic) 32. The processing circuitry 32 controls the operation of the third node 30 and can implement the method described herein. The processing circuitry 32 can comprise one or more processors, processing units, multi-core processors or modules that are configured or programmed to control the third node 30 in the manner described herein. In particular implementations, the processing circuitry 32 of the third node 30 can comprise a plurality of software and/or hardware modules that are each configured to perform, or are for performing, individual or multiple steps of the method described herein.

Briefly, the processing circuitry 32 of the third node 30 is configured to, in response to receiving a string identity for the remote UE, acquire, from a first node 10, an identity of the remote UE that is stored in a memory with the string identity for the remote UE and establish a connection between the remote UE and the cellular network via a relay UE connected to the cellular network using the identity of the remote UE. As described earlier, the string identity for the remote UE comprises a cryptographic function applied to the identity of the remote UE.

As illustrated in FIG. 6, in some embodiments, the third node 30 may optionally comprise a memory 34. The memory 34 of the third node 30 can comprise a volatile memory or a non-volatile memory. In some embodiments, the memory 34 of the third node 30 may comprise a non-transitory media. Examples of the memory 34 of the third node 30 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 32 of the third node 30 can be connected to the memory 34 of the third node 30. In some embodiments, the memory 34 of the third node 30 may be for storing program code or instructions which, when executed by the processing circuitry 32 of the third node 30, cause the third node 30 to operate in the manner described herein in respect of the third node 30. For example, in some embodiments, the memory 34 of the third node 30 may be configured to store program code or instructions that can be executed by the processing circuitry 32 of the third node 30 to cause the third node 30 to operate in accordance with the method described herein in respect of the third node 30. Alternatively or in addition, the memory 34 of the third node 30 can be configured to store any information (e.g. the identity of the remote UE and/or the string identity for the remote UE), data, messages, requests, responses, indications, notifications, signals, or similar, that are described herein. The processing circuitry 32 of the third node 30 may be configured to control the memory 34 of the third node 30 to store any information (e.g. the identity of the remote UE and/or the string identity for the remote UE), data, messages, requests, responses, indications, notifications, signals, or similar, that are described herein.

In some embodiments, as illustrated in FIG. 6, the third node 30 may optionally comprise a communications interface 36. The communications interface 36 of the third node 30 can be connected to the processing circuitry 32 of the third node 30 and/or the memory 34 of third node 30. The communications interface 36 of the third node 30 may be operable to allow the processing circuitry 32 of the third node 30 to communicate with the memory 34 of the third node 30 and/or vice versa. Similarly, the communications interface 36 of the third node 30 may be operable to allow the processing circuitry 32 of the third node 30 to communicate with the first node 10, the second node 20, and/or any other node. The communications interface 36 of the third node 30 can be configured to transmit and/or receive any information (e.g. the identity of the remote UE and/or the string identity for the remote UE), data, messages, requests, responses, indications, notifications, signals, or similar, that are described herein. In some embodiments, the processing circuitry 32 of the third node 30 may be configured to control the communications interface 36 of the third node 30 to transmit and/or receive any information (e.g. the identity of the remote UE and/or the string identity for the remote UE), data, messages, requests, responses, indications, notifications, signals, or similar, that are described herein.

Although the third node 30 is illustrated in FIG. 6 as comprising a single memory 34, it will be appreciated that the third node 30 may comprise at least one memory (i.e. a single memory or a plurality of memories) 34 that operate in the manner described herein. Similarly, although the third node 30 is illustrated in FIG. 6 as comprising a single communications interface 36, it will be appreciated that the third node 30 may comprise at least one communications interface (i.e. a single communications interface or a plurality of communications interface) 36 that operate in the manner described herein. It will also be appreciated that FIG. 6 only shows the components required to illustrate an embodiment of the third node 30 and, in practical implementations, the third node 30 may comprise additional or alternative components to those shown.

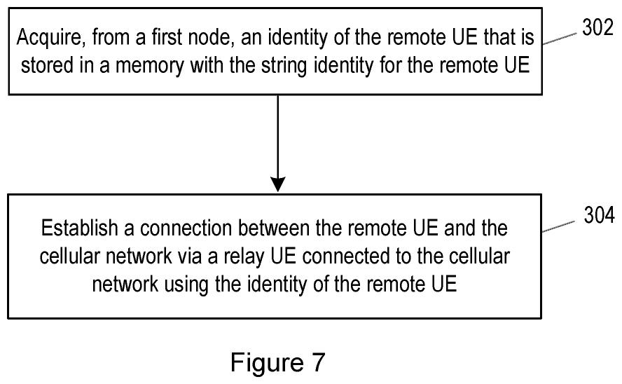

FIG. 7 is a flowchart illustrating a method performed by a third node 30 in accordance with an embodiment. The method is for use in connecting a remote UE to a cellular network. The third node 30 described earlier with reference to FIG. 6 is configured to operate in accordance with the method of FIG. 7. The method can be performed by or under the control of the processing circuitry 32 of the third node 30.

As illustrated at block 302 of FIG. 7, in response to receiving a string identity for the remote UE, an identity of the remote UE that is stored in a memory (e.g. the memory 14 of the first node 10 or any other memory) with the string identity for the remote UE is acquired from a first node 10. More specifically, the processing circuitry 32 of the third node 30 acquires the identity of the remote UE.

At block 304 of FIG. 7, a connection is established between the remote UE and the cellular network via a relay UE connected to the cellular network using the identity of the remote UE. More specifically, the processing circuitry 32 of the third node 30 establishes this connection.

As mentioned earlier, the string identity for the remote UE comprises a cryptographic function applied to the identity of the remote UE. In some embodiments, the string identity for the remote UE may comprise the cryptographic function applied to the identity of the remote UE together with random data appended to the identity of the remote UE. That is, in some embodiments, the string identity for the remote UE may comprise the cryptographic function applied to a concatenation of the identity of the remote UE and the random data. In some embodiments, the string identity referred to herein may be a string identity of at least 256 bits (i.e. 256 bits or more than 256 bits) for the remote UE or at least 128 bits (i.e. 128 bits or more than 128 bits) for the remote UE. In some embodiments, the string identity for the remote UE may be a truncated string identity. For example, in some embodiments, the string identity referred to herein may be a truncated string identity of 128 bits or less. In some embodiments, the cryptographic function may be any of the cryptographic functions described earlier, such as a cryptographic hash function (e.g. SHA-2), a KDF (e.g. pbkdf2), a HMAC function, or any other cryptographic function.

There is also provided a system comprising, one or more first nodes 10 as described earlier with reference to FIGS. 2 and 3, one or more second nodes 20 as described earlier with reference to FIGS. 4 and 5, and/or one or more third nodes 30 as described earlier with reference to FIGS. 6 and 7. In some embodiments, the system can also comprise one or more remote UEs as described earlier.

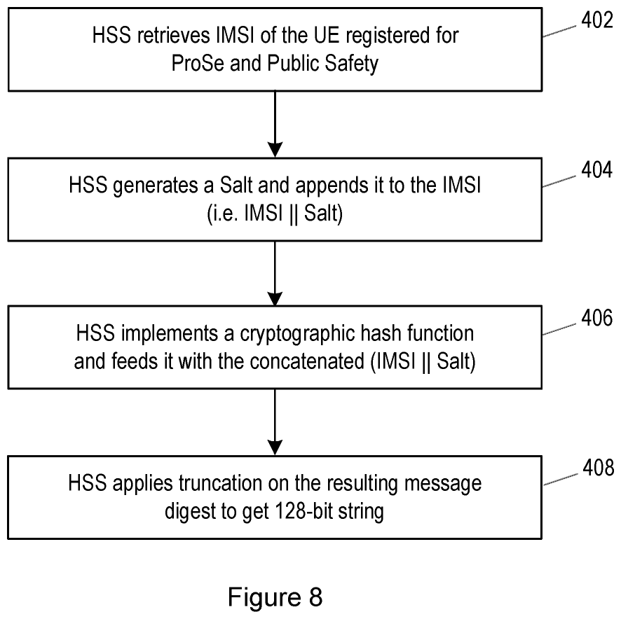

FIG. 8 is a block diagram illustrating a method performed by a first node 10 according to an embodiment. The method is for use in connecting a remote UE to a cellular network. The first node 10 described earlier with reference to FIG. 2 may be configured to operate in accordance with the method of FIG. 8. The method of FIG. 8 can be performed by or under the control of the processing circuitry 12 of the first node 10 according to some embodiments. In the embodiment illustrated in FIG. 8, the first node 10 can be a HSS. However, although this is provided as an example, it will be understood that the first node 10 may be another node according to other embodiments.

As illustrated in FIG. 8, at block 402, the first node 10 acquires (e.g. retrieves) an identity (e.g. the IMSI) of the remote UE. More specifically, the processing circuitry 12 of the first node 10 acquires the identity of the remote UE. The remote UE may be registered for a ProSe and/or public safety service in some embodiments.

At block 404 of FIG. 8, the first node 10 generates random data (e.g. a salt). More specifically, the processing circuitry 12 of the first node 10 generates the random data. As also illustrated at block 404 of FIG. 8, the first node 10 appends the random number to the identity of the remote UE. More specifically, the processing circuitry 12 of the first node 10 appends the random data to the identity of the remote UE according to the embodiment illustrated in FIG. 8. That is, a concatenation of the identity of the remote UE and the random data is generated.

At block 406 of FIG. 8, the first node 10 applies a cryptographic function to the identity of the remote UE together with the random data appended to the identity of the remote UE to generate a string identity for the remote UE. More specifically, the processing circuitry 12 of the first node 10 applies the cryptographic function to the identity of the remote UE together with the random data appended to the identity of the remote UE to generate the string identity for the remote UE. That is, the first node 10 implements a cryptographic function and feeds it with the concatenated identity of the remote UE and random data. The cryptographic function can, for example, be a cryptographic hash function according to the embodiment illustrated in FIG. 8. Thus, the string identity can be referred to as a message digest.

At block 408 of FIG. 8, the first node 10 truncates the string identity for the remote UE. More specifically, the processing circuitry 12 of the first node 10 truncates the string identity for the remote UE. For example, the string identity may be a truncated string identity of 128 bits according to some embodiments. Although not illustrated in FIG. 8, the first node 10 stores, in the memory (e.g. the memory 14 of the first node 10 and/or any other memory), the truncated string identity for the remote UE with the identity of the remote UE for use in connecting the remote UE to the cellular network via the relay UE connected to the cellular network. More specifically, the processing circuitry 12 of the first node 10 stores the truncated string identity for the remote UE in the memory with the identity of the remote.

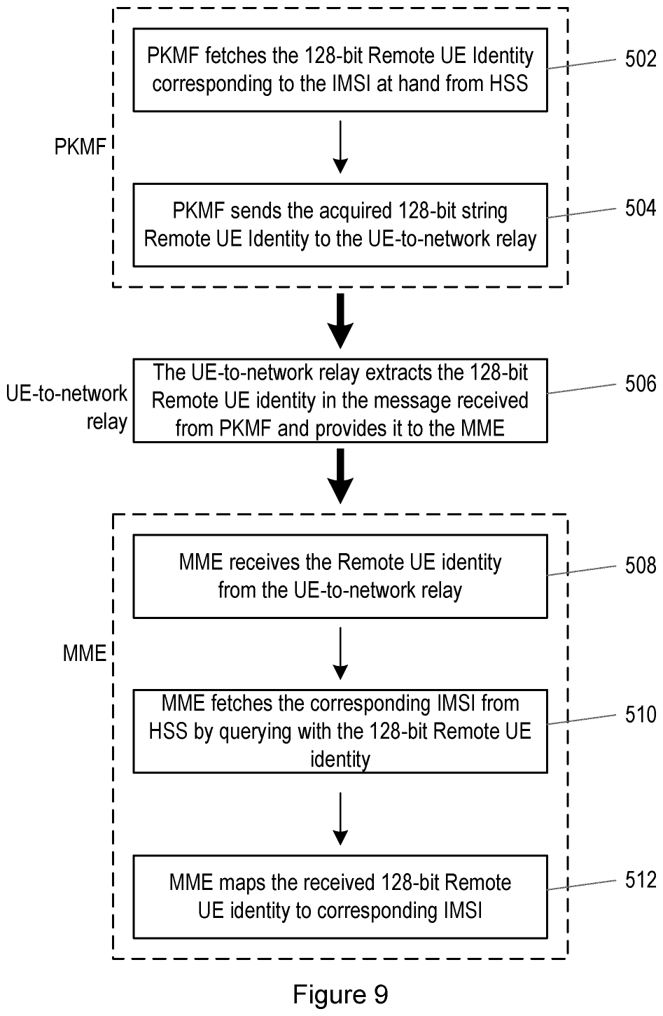

FIG. 9 is a block diagram illustrating a method performed by a second node 20 and a third node 30 according to an embodiment. The second node 20 described earlier with reference to FIG. 4 and the third node 30 described earlier with reference to FIG. 6 may be configured to operate in accordance with the method of FIG. 9. The method of FIG. 9 can be performed by or under the control of the processing circuitry 22 of the second node 20 and the processing circuitry 32 of the third node 30 according to some embodiments. In the embodiment illustrated in FIG. 9, the second node 20 is a PKMF node and the third node 30 is a MME node. However, although this is provided as an example, it will be understood that the second node 20 and the third node 30 may be other nodes according to other embodiments.

In the embodiment illustrated in FIG. 9, the remote UE has a valid user key for the relay UE and associated identity (ID) of the user key for the relay UE. For example, in a ProSe embodiment, the remote UE can have a valid ProSe relay user key (PRUK) and an associated PRUK ID for the relay UE. The identity of the user key for the relay UE, e.g. the PRUK ID, is recognised by the second node 20.

As illustrated in FIG. 9, at block 502, the second node 20 acquires (e.g. fetches) a string identity for the remote UE from a first node 10, e.g. a HSS. More specifically, the processing circuitry 22 of the second node 20 acquires the string identity for the remote UE from the first node 10. The string identity corresponds to the actual identity of the remote UE. In the embodiment illustrated in FIG. 9, the string identity of the remote UE is illustrated as comprising 128 bits. However, it will be understood that the string identity may instead comprise any other number of bits.

As block 504 of FIG. 9, the second node 20 initiates transmission (or sending) of the acquired string identity for the remote UE towards a relay UE (or UE-to-network relay) connected to the cellular network for use in connecting the remote UE to the cellular network via the relay UE. More specifically, the processing circuitry 22 of the second node 20 initiates transmission of the string identity for the remote UE towards the relay UE connected to the cellular network.

At block 506 of FIG. 9, the relay UE acquires (e.g. receives) the string. In some embodiments, the second node 20 may transmit the string identity in a message and the relay UE may then extract the string identity for the remote UE from the message received from the second node 20. The relay UE can then provide the string identity for the remote UE. Thus, the relay UE may initiate transmission (or sending) of the acquired string identity for the remote UE towards a third node 30, e.g. a MME.

At block 508 of FIG. 9, the third node 30 receives the string identity for the remote UE. More specifically, the processing circuitry 32 of the third node 30 receives (e.g. via the communications interface 36 of the third node 30) receives the string identity for the remote UE. In the embodiment illustrated in FIG. 9, the string identity for the remote UE is received from the relay UE. At block 508 of FIG. 9, the third node 30 acquires (e.g. fetches), from the first node 10, an identity of the remote UE that is stored in a memory (e.g. the memory 14 of the first node 10 or any other memory) with the string identity for the remote UE. More specifically, the processing circuitry 32 of the third node 30 acquires the identity of the remote UE. For example, the third node 30 may query the first node 10 with the string identity for the remote UE.

Thus, according to the embodiment illustrated in FIG. 9, the second node 20 (e.g. the PKMF) can retrieve the string identity for the remote UE from the first node 10 (e.g. the HSS) and send it to the relay UE that provides it to the third node 30 (e.g. the MME). At block 512 of FIG. 9, the third node 30 can map the string identity for the remote UE to the corresponding identity of the remote UE. More specifically, the processing circuitry 32 of the third node 30 can perform this mapping. In more detail, as the first node 10 stores the string identity for the remote UE with the identity of the remote UE, the third node 30 can acquire the identity of the remote UE from the first node 10 and can thus establish a connection between the remote UE and the cellular network via the relay UE using the identity of the remote UE. More specifically, the processing circuitry 32 of the third node 30 can acquire the identity of the remote UE and establish the connection. In this way, the whole method can continue to proceed without exposing the real identity of remote UE to the relay UE.

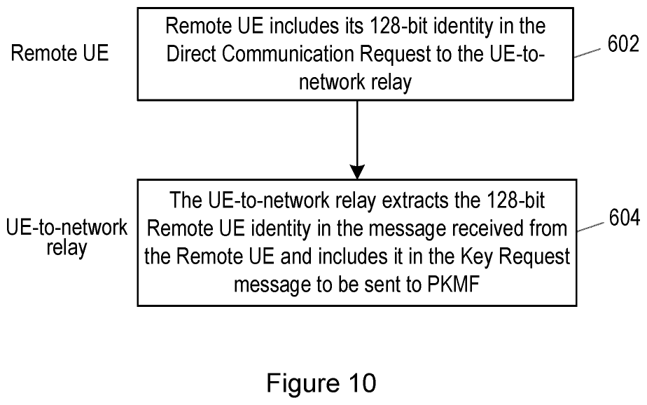

FIG. 10 is a block diagram illustrating a method performed by a second node 20 according to an embodiment. The second node 20 described earlier with reference to FIG. 4 may be configured to operate in accordance with the method of FIG. 10. The method of FIG. 10 can be performed by or under the control of the processing circuitry 22 of the second node 20. In the embodiment illustrated in FIG. 10, the second node 20 is a remote UE. However, although this is provided as an example, it will be understood that the second node 20 may be another node according to other embodiments.

In the embodiment illustrated in FIG. 10, the second node 20 does not have a user key for the relay node connected to the cellular network for use in connecting the remote UE to the cellular network or the user key for the relay node has been rejected. Although not illustrated in FIG. 10, the second node 20 acquires its string identity from the first node 10. More specifically, the processing circuitry 22 of the second node 20 acquires its string identity from the first node 10.

As illustrated in FIG. 10, at block 602, the second node 20 initiates transmission of its string identity towards the relay UE. More specifically, the processing circuitry 22 of the second node 20 initiates transmission of its string identity towards the relay UE. For example, the second node 20 may include its string identity in a direct communication request message transmitted towards the relay UE.

At block 604 of FIG. 10, in response to receiving the direct communication request message, the relay UE extracts the string identity for the remote UE and includes it in a key request message to be sent to the third node 30. The relay UE can initiate transmission of the key request message comprising the string identity for the remote UE towards a third node 30. In the embodiment illustrated in FIG. 10, the third node 30 is a PKMF node. However, although this is provided as an example, it will be understood that the third node 30 may be another node (e.g. an MME node) according to other embodiments.

The third node 30 may be configured to operate in the manner described earlier by or under the control of the processing circuitry 32 of the third node 30. Although not illustrated in FIG. 10, in response to receiving the string identity for the remote UE, the third node 30 can acquire, from the first node 10, the identity of the remote UE that is stored in the memory with the string identity for the remote UE. For example, the third node 30 can query the first node 10. Since the first node 10 stores the string identity for the remote UE with the identity of the remote UE, the third node 30 can acquire the identity of the remote UE and can thus establish the connection between the remote UE and the cellular network via the relay UE using the identity of the remote UE. In the illustrated embodiment of FIG. 10, the third node 30 is a PKMF node.

However, in a similar way, an MME node may acquire the identity of the remote UE and establish the connection. In this way, the whole method can continue to proceed without exposing the real identity of remote UE to the relay UE.

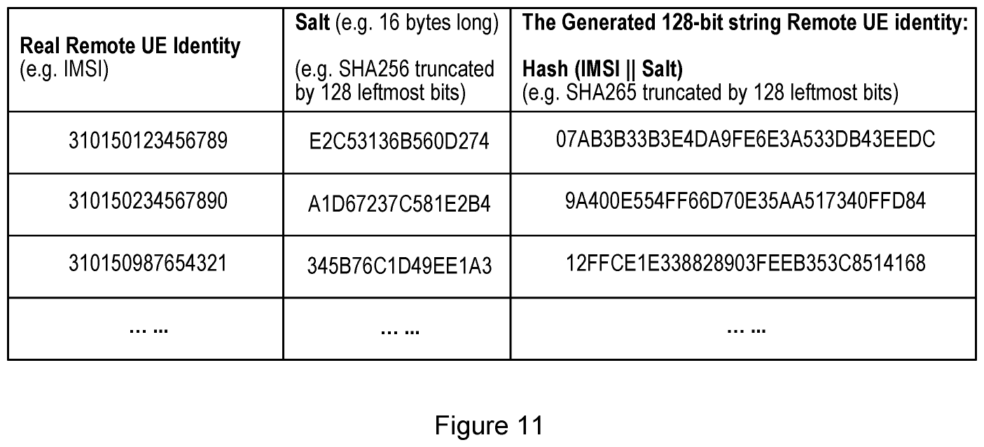

FIG. 11 is an example of information stored in a memory according to an embodiment. As illustrated in FIG. 11, in some embodiments, the information stored in the memory, such as the memory 14 of the first node 10 described earlier or any other memory, can comprise the real identity (e.g. the IMSI) of the remote UE and the string identity generated for the remote UE. As illustrated in FIG. 11, in some embodiments, the information stored in this memory may also comprise random data (e.g. a salt) if this is also used in the generation of the string identity for the remote UE.

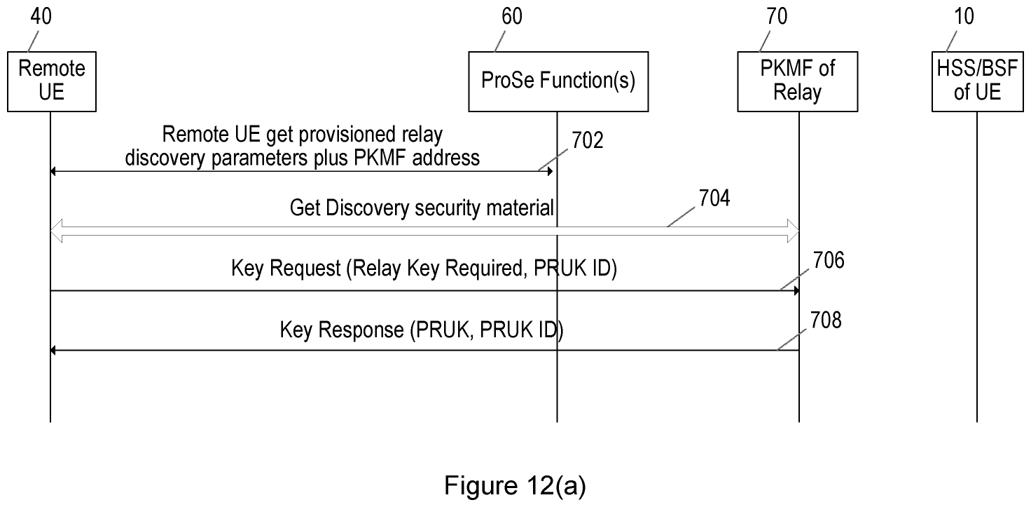

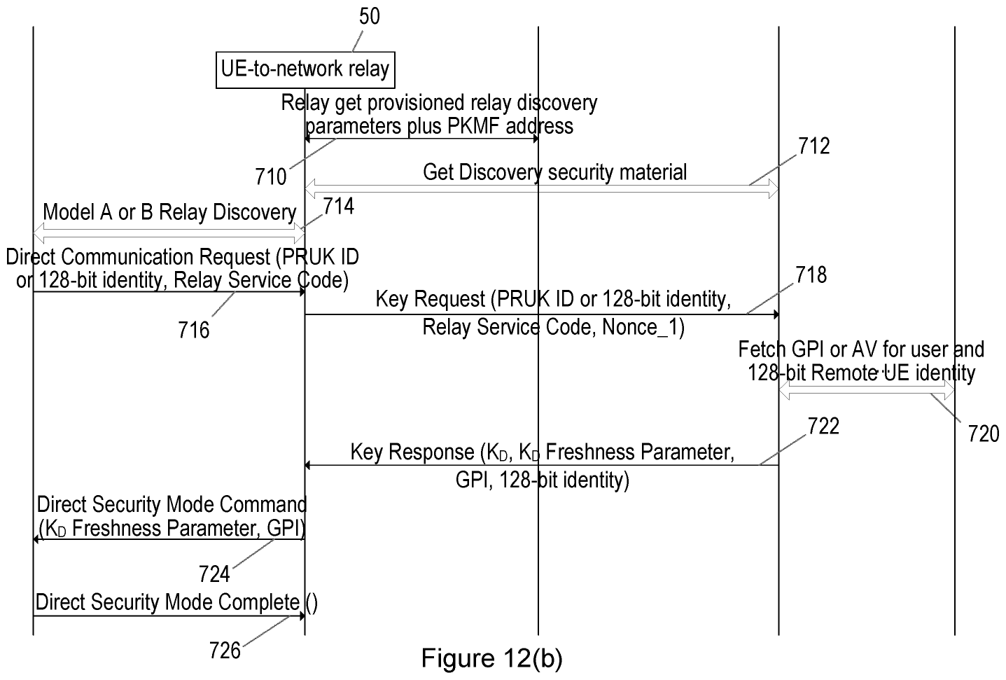

FIG. 12(a)-(b) is a signalling (or call flow) diagram illustrating an exchange of signals in such a system according to an embodiment. The system illustrated in FIG. 12(a)-(b) comprises a remote UE 40, a relay UE 50 (which may also be referred to as a UE-to-network relay) as described earlier, one or more functions (e.g. one or more ProSe functions) 60, a PKMF node 70 of the relay node 50, and a first node 10 as described earlier with reference to FIG. 2. In the illustrated embodiment of FIG. 12(a)-(b), the remote UE 40 operates as the second node 20 as described earlier with reference to FIG. 4. Although not illustrated in FIG. 3, the system may also comprise the third node 30 as described earlier with reference to FIG. 6. The third node 30 can be an MME node.

As illustrated by arrows 702, 704, 710, 712 of FIG. 12(a)-(b), the remote UE 40 and the relay UE 50 fetch the parameters necessary to act as a remote UE 40 and relay UE 50 respectively, the address of the PKMF node 70 of the relay UE 50 for accessing the relay UE 50 and the security parameters required to protect the relay discovery messages. As illustrated in FIG. 12(a)-(b), the remote UE 40 may communicate with the one or more functions (e.g. one or more ProSe functions) 60 and/or the PKMF node 70 of the relay node 50 for this purpose.

As illustrated by arrow 706 of FIG. 12(a), the remote UE 40 sends a key request message to the PKMF node 70 of the relay UE 50. In the illustrated embodiment of FIG. 12(a)-(b), the message indicates that the remote UE 40 is requesting a PRUK for the relay UE 50 from the PKMF node 70. If the remote UE 40 already has a PRUK for the relay UE 50 from this PKMF node 70, the message may also contain the PRUK ID of the PRUK for the relay UE 50. The PKMF node 70 checks whether the remote UE 40 is authorised to connect to the cellular network via (e.g. receive a service from) one of its relay UEs. This can be performed by using the remote UE 40 identity that is bound to keys that established a transport layer security (TLS) tunnel in which the message is sent.

As illustrated by arrow 708 of FIG. 12(a), the PKMF node 70 sends a key response message to the remote UE 40 indicative of whether the remote UE 40 is authorised to connect to the cellular network via (e.g. receive a service from) a relay UE 50. If the remote UE 40 is successfully authorized, the key response message may contain a PRUK and PRUK ID for the relay UE 50. If a PRUK and PRUK ID for the relay UE 50 are included, the remote UE 40 may store these and delete any previously stored PRUK and PRUK ID for the relay UE 50.

As illustrated by arrow 714 of FIG. 12(b), the remote UE 40 discovers the relay UE 50. For example, the remote UE 40 may use either model A or model B discovery. Model A discovery involves one UE announcing “I am here”, whereas Model B discovery involves one UE asking “who is there” and/or “are you there”.

As illustrated by arrow 716 of FIG. 12(b), if the remote UE 40 is successfully authorised, the remote UE 40 initiates transmission of a string identity for the remote UE 40 towards the relay UE 50 connected to the cellular network for use in connecting the remote UE 40 to the cellular network via the relay UE 50. Although not illustrated in FIG. 12(a)-(b), the remote UE 40 acquires the string identity for the remote UE 40 from the first node 10 described earlier (e.g. the HSS). The string identity for the remote UE 40 comprises a cryptographic function applied to the identity of the remote UE 40. The remote UE 40 initiates transmission of the string identity for the remote UE 40 towards the relay UE 50 connected to the cellular network for use in connecting the remote UE 40 to the cellular network via the relay UE 50. For example, as illustrated in FIG. 12(b), the remote UE 40 may initiate transmission of a direct communication request towards the relay UE 50 and this direct communication request can comprise the string identity for the remote UE 40. Thus, the remote UE 40 operates as the second node 20 described earlier.

In some embodiments, if the remote UE 40 has a PRUK for the relay UE 50 that it wants to use for connectivity and an attempt to connect to this relay UE 50 has not been rejected due to the PRUK ID for the relay UE 50 not being recognised, then the direct communication request may instead comprise the PRUK ID of the PRUK for the relay UE 50. Otherwise the remote UE 40 uses the string identity for the remote UE 40 in the direct communication request. Thus, the relay UE 50 receives the string identity for the remote UE 40. As illustrated in FIG. 12(a)-(b), in some embodiments the string identity may be a 128 bit string identity. However, it will be understood that other length string identities are also possible and this is just one example. The direct communication request may also comprise a relay service code that the remote UE 40 wishes to access.

As illustrated by arrow 718 of FIG. 12(b), the relay UE 50 may send a key request message to the PKMF node 70. This key request message can comprise the PRUK ID for the relay UE 50 or the string identity for the remote UE 40. The key request message may also comprise the relay service code and a nonce (namely, Nonce_1) that is provided by the remote UE 40. The PKMF node 70 identifies the UE by the PRUK ID for the relay UE 50 or the string identity for the remote UE 40. The PKMF node 70 may check the context of the remote UE 40 to confirm whether it can connect to the cellular network via the selected relay UE 50, e.g. for the given relay service code.

If the PKMF node 70 confirms the remote UE 40 can connect to the cellular network via the selected relay UE 50, as illustrated by arrow 720 of FIG. 12(b), the PKMF node 70 may decide if it requires a new PRUK for the relay UE 50. For example, a policy in the PKMF node 70 may decide that the PRUK ID for the relay UE 50 needs refreshing or the relay UE 50 provided the string identity for the remote UE 40. If a new PRUK is required for the relay UE 50 or the relay UE 50 provided the string identity for the remote UE 40, the PKMF node 70 may proceed accordingly. For example, the PKMF node 70 may request a generic bootstrapping architecture (GBA) push information (GPI) and/or an authentication vector (AV) for the remote UE 40 from the first node 10.

As illustrated by arrow 722 of FIG. 12(b), the PKMF node 70 initiates transmission of a key response message towards the relay UE 50. The key response message comprises the string identity for the remote UE 40. The PKMF node 70 may generate a random number as a freshness parameter for a root key K_{D} shared between the remote UE 40 and the relay UE 50. The PKMF node 70 may use the PRUK to calculate the root key K_{D} with the relay service code, the nonce (namely, Nonce_1) and the freshness parameter for K_{D} as inputs. The key response message may also comprise K_{D}, the freshness parameter for K_{D} and the GPI if used to calculate a fresh PRUK to the relay UE 50.

As illustrated by arrow 724 of FIG. 12(b), the relay UE 50 initiates transmission of a direct security mode message (or command) towards the remote UE 40. The relay UE 50 can use the supplied K_{D} to protect the direct security mode message. The direct security mode message may comprise the freshness parameter for K_{D} and the GPI if they were received from the PKMF node 70. If the remote UE 40 receives the GPI, it may calculate a new PRUK and associated PRUK ID for the relay UE 50. The remote UE 40 can derive K_{D} from its PRUK and the received freshness parameter for K_{D}, the nonce (namely, Nonce_1) and the relay service code. The remote UE 40 may then process the direct security mode message. If this is successful, as illustrated by arrow 726 of FIG. 12(b), the remote UE 40 may initiate transmission of a direct security mode complete message towards the relay UE 50. The remote UE 40 and the relay UE 50 may start to exchange data, e.g. user data.

In more detail, as mentioned earlier, the relay UE 50 receives the string identity for the remote UE 40. The relay UE 50 can initiate transmission of the string identity towards an MME node, which is not illustrated in FIG. 12(a)-(b). In response to receiving a string identity for the remote UE 40, the MME node can acquire, from the first node 10, the identity of the remote UE 40 that is stored in a memory with the string identity for the remote UE 40. For example, the MME node can query the first node 10. Since the first node 10 stores the string identity for the remote UE 40 with the identity of the remote UE 40, the MME node can acquire the identity of the remote UE and can thus establish the connection between the remote UE 40 and the cellular network via the relay UE 50 using the identity of the remote UE 40. Thus, the MME node can operate as the third node 30 described earlier. In a similar way, the PKMF node 70 may acquire the identity of the remote UE 40. In this way, the whole method can continue to proceed without exposing the real identity of remote UE 40 to the relay UE 50.

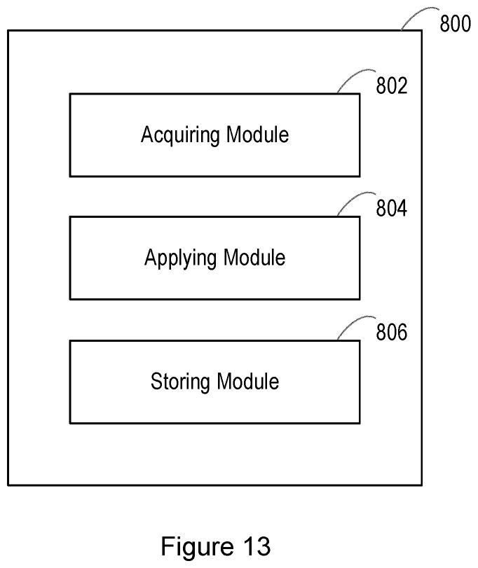

FIG. 13 is a block diagram illustrating a first node 800 in accordance with an embodiment. The first node 800 comprises an acquiring module 802 configured to acquire an identity of the remote UE. The first node 800 comprises an applying module 804 configured to apply a cryptographic function to the identity of the remote UE to generate a string identity for the remote UE. The first node 800 comprises a storing module 806 configured to store, in a memory, the string identity for the remote UE with the identity of the remote UE for use in connecting the remote UE to the cellular network via a relay UE connected to the cellular network. The first node 800 may operate in the manner described herein.

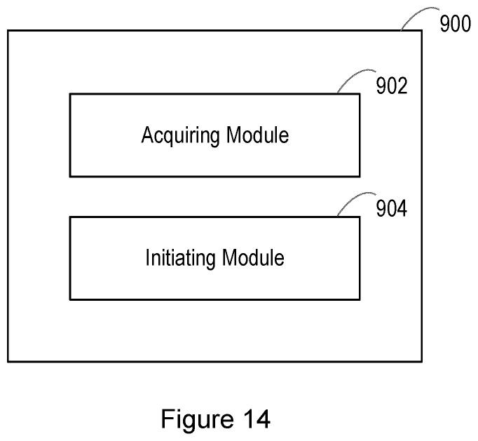

FIG. 14 is a block diagram illustrating a second node 900 in accordance with an embodiment. The second node 900 comprises an acquiring module 902 configured to acquire a string identity for the remote UE from a first node 800. The second node 900 comprises an initiating module 904 configured to initiate transmission of the string identity for the remote UE towards a relay UE connected to the cellular network for use in connecting the remote UE to the cellular network via the relay UE. The string identity for the remote UE comprises a cryptographic function applied to the identity of the remote UE. The second node 900 may operate in the manner described herein.

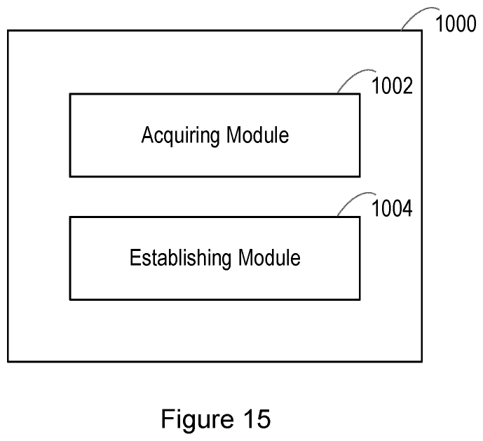

FIG. 15 is a block diagram illustrating a third node 1000 in accordance with an embodiment. The third node 1000 comprises an acquiring module 1002 configured to, in response to receiving a string identity for the remote UE, acquire, from a first node 800, an identity of the remote UE that is stored in a memory with the string identity for the remote UE. The third node 1000 comprises an establishing module 1004 configured to establish a connection between the remote UE (40) and the cellular network via a relay UE connected to the cellular network using the identity of the remote UE. The string identity for the remote UE comprises a cryptographic function applied to the identity of the remote UE. The third node 1000 may operate in the manner described herein.

There is also provided a computer program comprising instructions which, when executed by processing circuitry (such as the processing circuitry 12 of the first node 10 described earlier, the processing circuitry 22 of the second node 20 described earlier, or the processing circuitry 32 of the third node 30 described earlier), cause the processing circuitry to perform at least part of the method described herein. There is provided a computer program product, embodied on a non-transitory machine-readable medium, comprising instructions which are executable by processing circuitry (such as the processing circuitry 12 of the first node 10 described earlier, the processing circuitry 22 of the second node 20 described earlier, or the processing circuitry 32 of the third node 30 described earlier) to cause the processing circuitry to perform at least part of the method described herein. There is provided a computer program product comprising a carrier containing instructions for causing processing circuitry (such as the processing circuitry 12 of the first node 10 described earlier, the processing circuitry 22 of the second node 20 described earlier, or the processing circuitry 32 of the third node 30 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

The node functionality described herein can be performed by hardware. Thus, any one or more nodes (e.g. the first node, second node and/or third node) described herein can be a hardware node. However, it will also be understood that at least part or all of the node functionality described herein can be virtualized. For example, the functions performed by any one or more nodes described herein can be implemented in software running on generic hardware that is configured to orchestrate the node functionality. Thus, in some embodiments, any one or more nodes (e.g. the first node, second node and/or third node) described herein can be a virtual node. In some embodiments, at least part or all of the node functionality described herein may be performed in a network enabled cloud. The node functionality described herein may all be at the same location or at least some of the node functionality may be distributed.

It will be understood that at least some or all of the method steps described herein can be automated in some embodiments. That is, in some embodiments, at least some or all of the method steps described herein can be performed automatically.

Thus, in the manner described herein, there is advantageously provided an improved technique for use in connecting a remote UE to a cellular network.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-20. (canceled)

21. A method performed by a first node for use in connecting a remote user equipment (UE) to a cellular network, the method comprising:
acquiring an identity of the remote UE;
applying a cryptographic function to the identity of the remote UE to generate a string identity for the remote UE; and
storing, in a memory, the string identity for the remote UE with the identity of the remote UE for use in connecting the remote UE to the cellular network via a relay UE connected to the cellular network.

22. The method of claim 21, the method comprising:
truncating the string identity for the remote UE; and
storing, in the memory, the truncated string identity for the remote UE with the identity of the remote UE for use in connecting the remote UE to the cellular network via the relay UE connected to the cellular network.

23. The method of claim 21, the method comprising:
appending random data to the identity of the remote UE; and
applying the cryptographic function to the identity of the remote UE together with the random data appended to the identity of the remote UE to generate the string identity for the remote UE.

24. The method of claim 21, the method comprising:
generating an updated string identity for the remote UE; and
storing, in the memory, the updated string identity for the remote UE with the identity of the remote UE for use in connecting the remote UE to the cellular network via the relay UE connected to the cellular network.

25. The method of claim 24, wherein generating an updated string identity for the remote UE comprises:
appending different random data to the identity of the remote UE; and
applying the cryptographic function to the identity of the remote UE together with the different random data appended to the identity of the remote UE to generate the updated string identity for the remote UE.

26. The method of claim 21, wherein:
acquiring the identity of the remote UE, applying the cryptographic function and storing the string identity for the remote UE are performed in response to the remote UE registering with the cellular network.

27. The method of claim 21, wherein:
the remote UE is registered for a proximity-based service (ProSe) and the cellular network is a ProSe-enabled cellular network.

28. A method performed by a second node for use in connecting a remote user equipment (UE) to a cellular network, the method comprising:
acquiring a string identity for the remote UE from a first node, wherein the string identity for the remote UE comprises a cryptographic function applied to the identity of the remote UE; and
initiating transmission of the string identity for the remote UE towards a relay UE connected to the cellular network for use in connecting the remote UE to the cellular network via the relay UE.

29. The method of claim 28, wherein:
the string identity for the remote UE is a truncated string identity; and/or
the string identity for the remote UE comprises the cryptographic function applied to the identity of the remote UE together with random data appended to the identity of the remote UE.

30. The method of claim 28, wherein:
the remote UE is registered for a proximity-based service (ProSe) and the cellular network is a ProSe-enabled cellular network.

31. A method performed by a third node for use in connecting a remote user equipment (UE) to a cellular network, the method comprising:
in response to receiving a string identity for the remote UE, wherein the string identity for the remote UE comprises a cryptographic function applied to the identity of the remote UE:
acquiring, from a first node, an identity of the remote UE that is stored in a memory with the string identity for the remote UE; and
establishing a connection between the remote UE and the cellular network via a relay UE connected to the cellular network using the identity of the remote UE.

32. The method of claim 31, wherein:
the string identity for the remote UE is a truncated string identity; and/or
the string identity for the remote UE comprises the cryptographic function applied to the identity of the remote UE together with random data appended to the identity of the remote UE.

33. The method of claim 31, wherein:
the remote UE is registered for a proximity-based service (ProSe) and the cellular network is a ProSe enabled cellular network.

34. An apparatus comprising:
communications interface circuitry configured to communicate with other nodes in a communications network; and
processing circuitry operatively coupled to the communications interface circuitry and configured to:
acquire a string identity for a remote user equipment (UE) from a first node, wherein the string identity for the remote UE comprises a cryptographic function applied to the identity of the remote UE; and
initiate transmission of the string identity for the remote UE towards a relay UE connected to the cellular network for use in connecting the remote UE to

35. The apparatus of claim 34, wherein:
the string identity for the remote UE is a truncated string identity; and/or
the string identity for the remote UE comprises the cryptographic function applied to the identity of the remote UE together with random data appended to the identity of the remote UE.

36. The apparatus of claim 34, wherein:
the remote UE is registered for a proximity-based service (ProSe) and the cellular network is a ProSe-enabled cellular network.

37. The apparatus of claim 34, wherein the apparatus is the remote UE or a key management function (KMF) of the relay UE.
